(19) United States
(12) Patent Application Publication
(10) Pub. No.: US 2007/0269253 A1
(43) Pub. Date: Nov. 22, 2007

(54) COMPOUND MIXING AND DISPENSING DEVICE

(76) Inventor: John Caro, Montclair, VA (US)

Correspondence Address: CAHN & SAMUELS LLP, 2000 P STREET NW, SUITE 200, WASHINGTON, DC, 20036, US

(21) Appl. No.: 11/745,351

(22) Filed: May 7, 2007

Related U.S. Application Data
(60) Provisional application No. 60/746,543, filed on May 5, 2006.

(51) Int. Cl. B43K 5/14; B43K 5/02

(52) U.S. Cl. 401/132; 222/94; 401/40; 401/42

(57) ABSTRACT

A device and method for accurately and quickly mixing and dispensing compounds, particularly reactant compounds. The device and method comprises at least one enclosed inner chamber that contains a reactant. The at least one or more enclosed inner chambers are in fluid communication with at least one mixing chamber. The reactants are displaced into the at least one mixing chamber and agitated such that they react. Once combined the reactants are released into an attached applicator and applied as needed.

### I. FIELD OF THE INVENTION

This invention relates to a system and device for packaging, mixing and dispensing reactive compounds quickly and precisely.

### II. BACKGROUND OF THE INVENTION

Reactive compounds are widely used adhesives that offer a variety of applications in many fields. These compounds are used for their ability to create and hold strong bonds with many materials in a wide range of environmental conditions. These compounds include, for example, reactive granules, liquids, powders, or gel that must be quickly and precisely measured and mixed prior to application. The risks of improperly mixing the compounds can be significant. If the reactants are not mixed quickly enough the compound risks premature hardening and difficulty applying which is likely to result in an inadequate bond. Similarly, if the reactants are not precisely measured and mixed the compound also risks forming an inadequate bond.

Adhesive compounds are often used in fields that rely on precision and appearance, for example dentistry, jewelry, crafts, etc. In these fields, adhesive compounds are preferred bonding agents due to their bonding strength as well as the ability to dye the compounds to match a broad range of colors and shades including colorless. These applications also require that the compounds be precisely applied. Further, many of these applications only require very small amounts of adhesive. However, producing very small batches can often present a problem with properly measuring ratios of the compound components. Whereas producing larger batches of the compound can lead to waste. Additionally, mixing these compounds can be very messy.

Notwithstanding the usefulness of the above-described methods, a need still exists for a device and method for quickly and accurately mixing adhesive compounds that may be precisely applied.

### III. SUMMARY OF THE INVENTION

This invention in at least one embodiment provides a compound mixing and dispensing device, comprising at least one inner chamber, wherein at least one reactant is enclosed inside the inner chamber; at least one mixing chamber fluidly connected to the at least one inner chamber; and an applicator in fluid communication with said at least one mixing chamber.

This invention in at least one embodiment provides a method for making a compound mixing and dispensing device, the method comprising enclosing at least one reactant inside at least one inner chamber; placing at least one mixing chamber in fluid communication with said at least one inner chamber; and placing an applicator in fluid communication with said at least one mixing chamber.

This invention in at least one embodiment provides a method of using a compound mixing and dispensing device, comprising causing at least one reactant sealed inside at least one inner chamber to be released into a mixing chamber; causing the at least one reactant to be mixed inside the mixing chamber; using an applicator in fluid communication with said mixing chamber to apply said mixed reactants.

The invention is a fully integrated and self-contained compound mixing and dispensing device. The device is capable of storing prepackaged compound components in one or more self-contained chambers. The components can be mixed by breaking the chambers to empty the contents into a larger chamber where they can be mixed. The chambers can be broken by squeezing the package such that the force exerted on the package breaks the smaller inner chambers such that their contents are released into the larger outer chamber. Mixing is performed by kneading the package between the fingers such that the contents from the broken chambers are thoroughly mixed. Once mixed the chamber can be opened by using a precise tear-away strip on a pour tab or by cutting the pour tab. The pour tab can be opened at various points to provide a desired opening size. This device provides a means for quickly and precisely mixing and dispensing reactive compounds.

Reactant compounds, such as adhesives, must often be applied promptly after mixing as they tend to harden and become difficult to work with quickly. These compounds also tend to require very accurate measuring of constituent components. When made in very small batches these measurements become even more critical. The device of the current invention allows a user to quickly and accurately mix compounds in small batches. This can lead to greater efficiency by avoiding waste of time and materials.

The present invention also includes a method of manufacturing a device for mixing and dispensing compounds. The device is assembled from sheets of plastic formed into chambers or pouches.

The device of the present invention finds particular application in environments where the use of more expensive and complicated applicators cannot be justified, but where the mixing and dispensing of properly proportioned compounds in a clean and disposable way is desired.

### IV. BRIEF DESCRIPTION OF THE DRAWINGS

Embodiments of the present invention will be described in detail with reference to the following figures, wherein:

FIG. 1 illustrates a top view of a section of a chamber and applicator of the present invention.

FIG. 2 illustrates a top view showing open chambers and applicator of the present invention.

FIG. 3 illustrates a top view of the chambers and dispenser of the present invention.

FIG. 4 illustrates a top view of a disassembled dispenser.

FIG. 5 illustrates a sectional view of the folded plastic strips of the invention.

FIG. 6 illustrates a top view of an open chamber with pouches inserted in accordance with the present invention.

FIG. 7 illustrates a top view of a completed dispenser of the present invention.

FIG. 8 illustrates a top view of a section of the present invention.

FIG. 9 illustrates a top view of open chambers of the present invention.

FIG. 10 illustrates a top view of a completed dispenser according to the present invention.

Given the following enabling description of the drawings, the apparatus should become evident to a person of ordinary skill in the art.

### V. DETAILED DESCRIPTION OF THE DRAWINGS

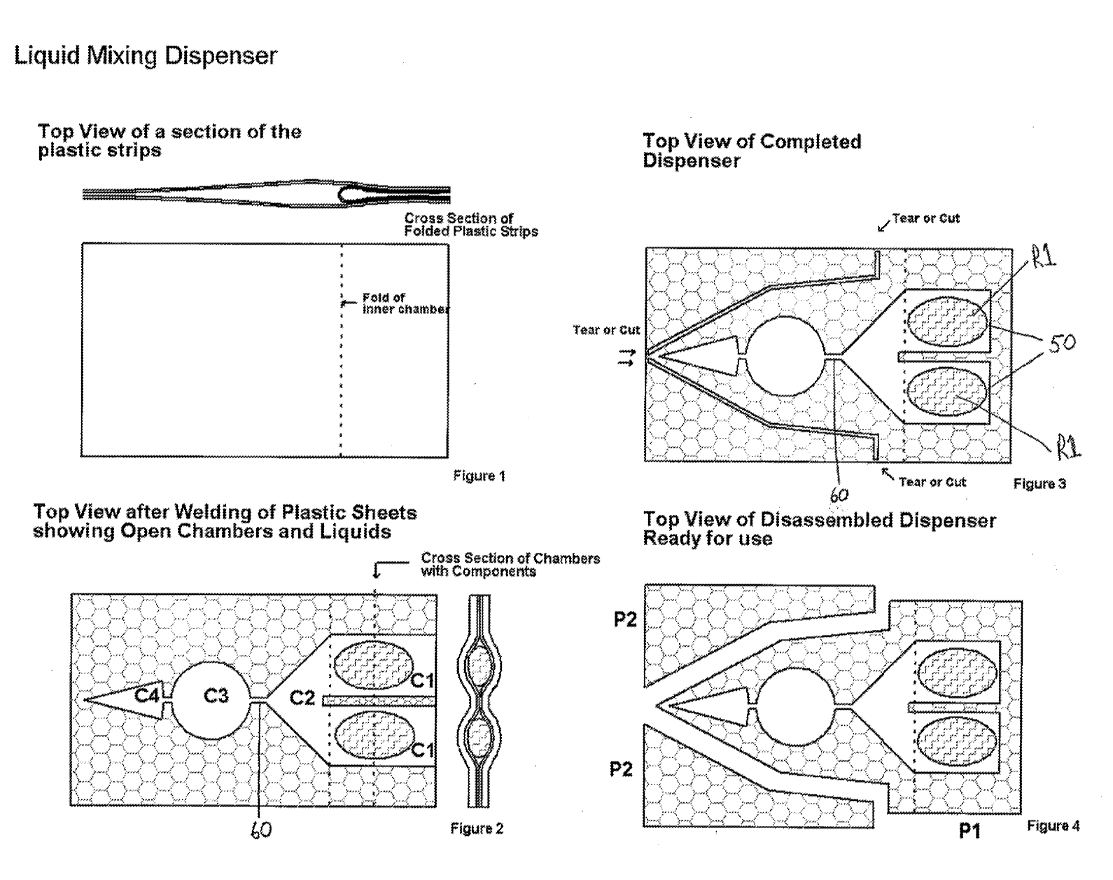

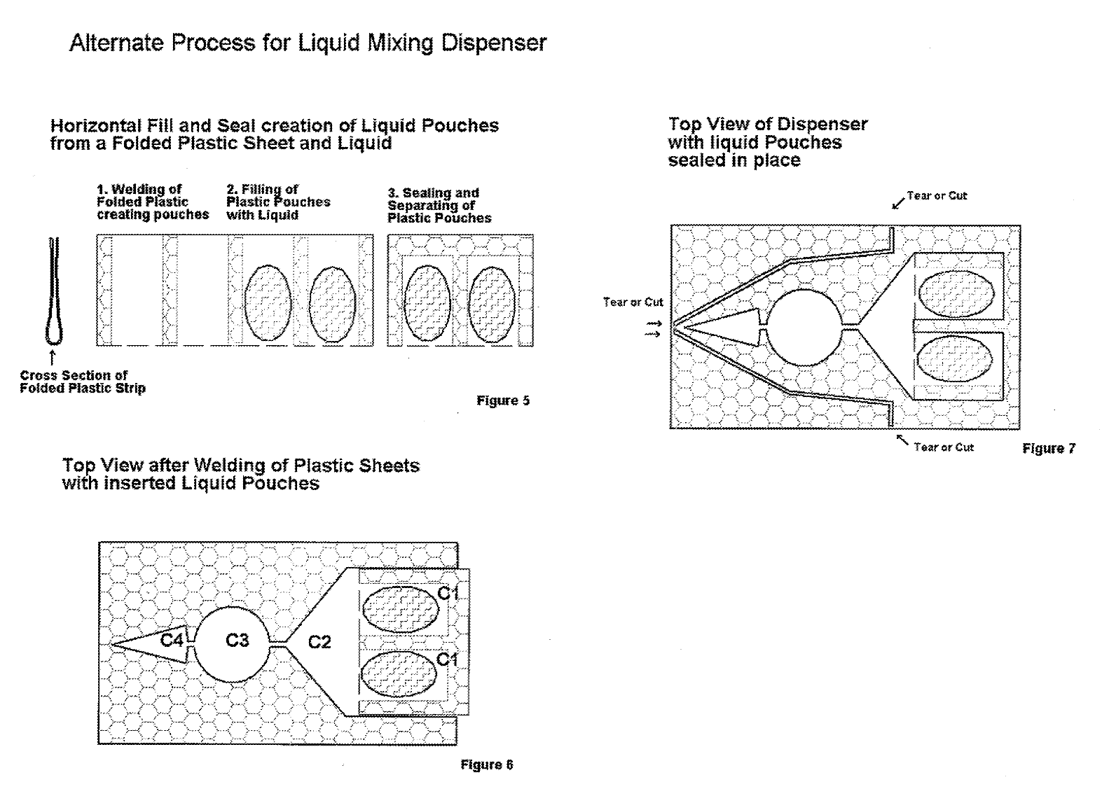

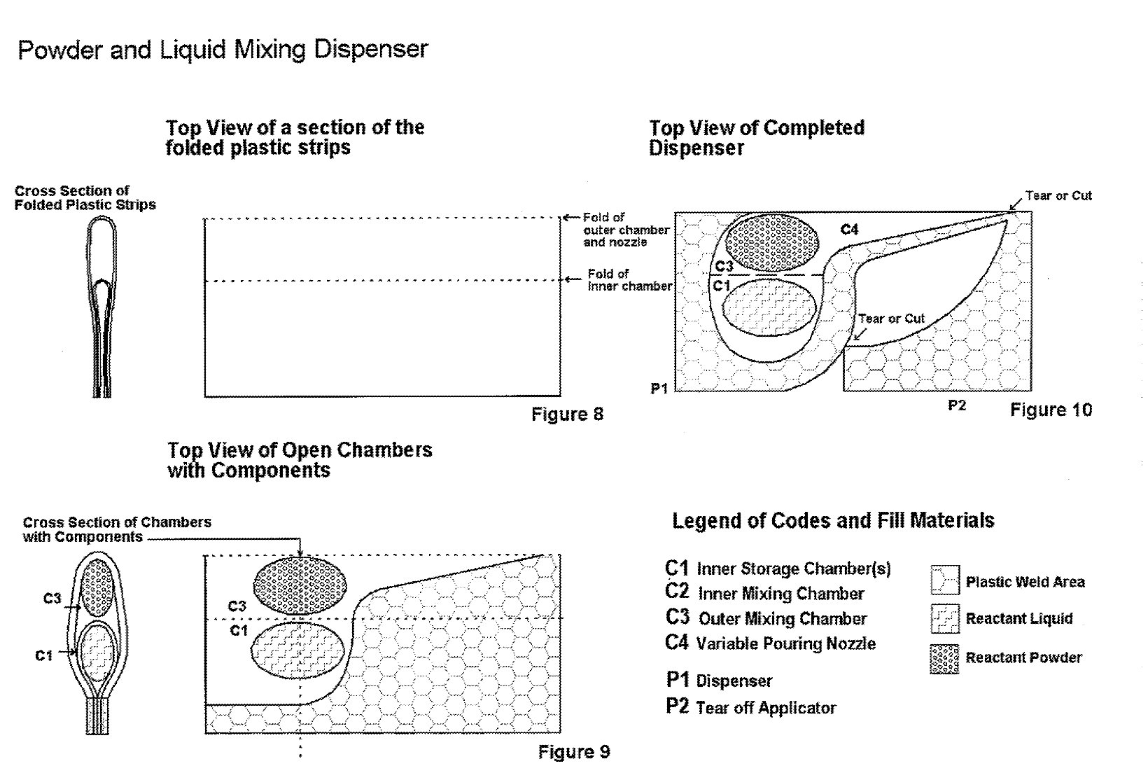

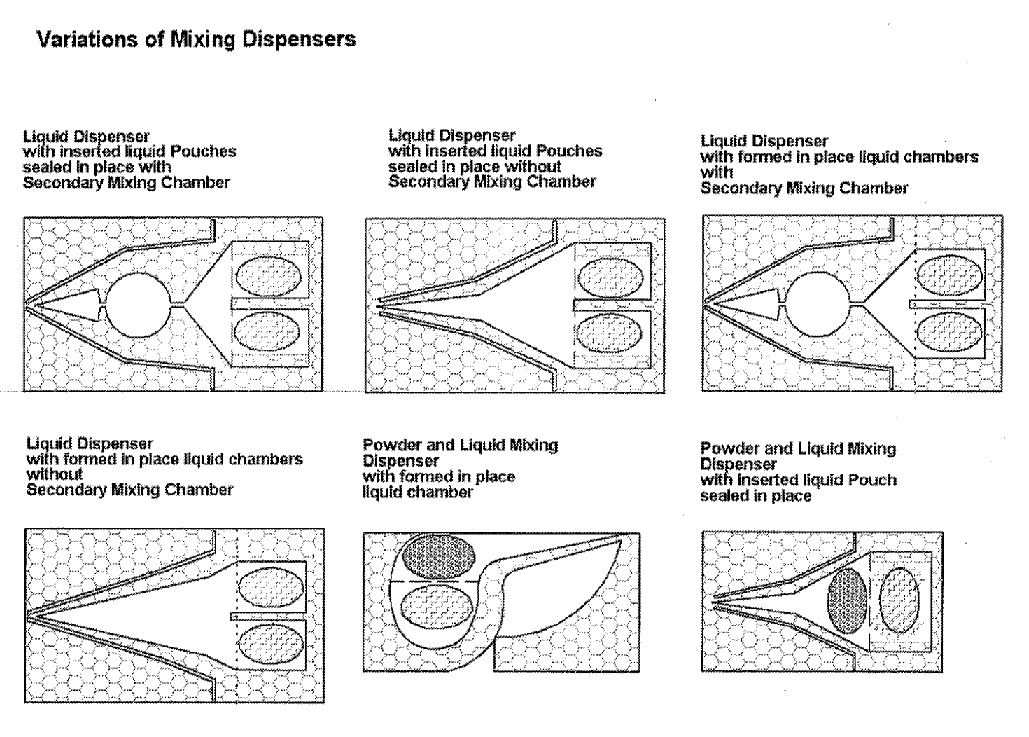

The device of the present invention, as shown in FIG. 1, provides a means for precisely mixing and dispensing compounds. The device is particularly usefully in mixing and dispensing reactant compounds. At least one reactant is accurately measured and stored in sealed chambers C1 of the device. The reactants, for instance R1, R2, R3, may be any substance that requires mixing prior to use, such as adhesives, epoxies, resins, polymers or the sort. The reactants may be in a variety of forms, including granular, liquid, powder, gel, etc. The reactants may be placed directly inside the sealed chambers C1 and may be further sealed inside a pouch 50.

The reactants R1, R2, R3 are enclosed in one or more inner chambers Cl, that are fluidly connected to an inner mixing chamber C2 and an outer mixing chamber C3. The inner chambers C1 are arranged such that the reactants may be released into the inner mixing chambers C2 where they are mixed. The inner chambers C1 may be typically opened by applying pressure, such as being squeezed. Once the inner chambers C1 and or pouches 50 containing the reactants are opened the reactants flow out into the inner chamber C2 and react with the other reactant(s) from the other inner chamber(s). The reactants are then combined and mixed by kneading the inner mixing chamber C2 so that all the reactants contained inside are combined.

The reactants are then forced from inner mixing chamber C2 into outer mixing C3. While being forced into outer mixing chamber C3, the reactants are passed through a restriction 60 formed between the inner mixing chamber C2 and outer mixing chamber C3. Forcing the reactants across the restriction 60 causes the individual reactants to combine. The reactants are thoroughly mixed by being repeatedly passed between inner mixing chamber C2 and outer mixing chamber C3 across the restriction 60. In the case of the embodiment of the present invention having no outer mixing chamber C3, the reactants are mixed by kneading them in the inner mixing chamber C2 until thoroughly mixed.

Once the reactants are thoroughly combined they are dispensed from the outer mixing chamber C3 (or inner mixing chamber C2 when no C3 is provided) into a variably sized pouring nozzle C4 connected to the outer mixing chamber C3. The variably sized nozzle applicator C4 allows the user to select the needed opening size. Once the needed opening sized is determined, the user separates the tear-away tab P2 at a position corresponding to the appropriate size. The applicator C4 can also be opened by other cutting means such as scissors.

The mixed contents are then dispensed from the applicator through the nozzle. The nozzle provides a means for accurately and precisely applying the contents of the chamber.

The chamber can include multiple enclosed reactant chambers with each chamber containing an accurately measured amount of reactant such that complex composites and the like can be mixed quickly and accurately. The device and method of the current invention allows a user to mix and dispense these compounds in small batches and on an as needed basis. This allows for greater efficiency by avoiding waste.

Multiple sealed chambers may be provided. Wherein each sealed chamber C1 may include a reactant either placed directly inside the sealed chamber C1 or sealed inside a pouch 50 that is placed inside the sealed chamber.

The device can be assembled from folded strips of plastic and can be manufactured in a high speed production process. This process includes a thinner folded strip or strips in the case of multiple chambers inserted fold first into the open side of a thicker and wider folded strip so that the open edges are aligned. (See FIG. 1). The folds of these strips form one of the walls of each of the inner and outer chambers and the variable size nozzle. The remaining walls of these chambers and the variable size nozzle are sealed and created by plastic welding operations. (FIG. 2).

The reactants are then deposited in the open side of the chambers. (See FIG. 2). The reactants in the chambers can be granular, powder, liquid, gel, etc., and are packaged such that the inner chambers burst from the application of pressure. Finally the devices are finished by a sealing operation that closes the openings of the chambers and a cutting operation that creates the removable applicator and separates the dispenser from the plastic roll. (See FIG. 3). The assembly of the device from of inner and outer rolls of plastic allows the device to be produced in a high speed production environment.

The exemplary and alternative embodiments described above may be combined in a variety of ways with each other. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

We claim:

1. A compound mixing and dispensing device, comprising:
at least one inner chamber, wherein at least one reactant is enclosed inside the inner chamber;
at least one mixing chamber fluidly connected to the at least one inner chamber; and
an applicator in fluid communication with said at least one mixing chamber.

2. The device according to claim 1, wherein said at least one mixing chamber comprises an inner mixing chamber and an outer mixing chamber.

3. The device according to claim 2, further comprising at least one restriction between said inner mixing chamber and said outer mixing chamber.

4. The device according to claim 1, further comprising multiple inner chambers each containing a different reactant.

5. The device according to claim 1, wherein said at least one reactant is sealed inside at least one pouch.

6. The device according to claim 1, wherein said at least one reactant is a liquid, powder, granular or gel reactant.

7. The device according to claim 1, wherein said at least one reactant comprises at least one adhesive.

8. The device according to claim 1, comprising a stick, swab or pin applicator.

9. A method for making a compound mixing and dispensing device, the method comprising:
enclosing at least one reactant inside at least one inner chamber;
placing at least one mixing chamber in fluid communication with said at least one inner chamber; and
placing an applicator in fluid communication with said at least one mixing chamber.

10. The method according to claim 9, further comprising:
wherein said at least one mixing chamber comprises an inner mixing chamber and an outer mixing chamber.

11. The device according to claim 10, further comprising:
providing at least one restriction between said inner mixing chamber and said outer mixing chamber.

12. The device according to claim 9, further comprising:
providing multiple inner chambers, wherein each inner chamber contains a different reactant.

13. The device according to claim 9, further comprising:
sealing at least one reactant inside at least one pouch.

14. A method of using a compound mixing and dispensing device, comprising:
causing at least one reactant sealed inside at least one inner chamber to be released into a mixing chamber;
causing the at least one reactant to be mixed inside the mixing chamber;
using an applicator in fluid communication with said mixing chamber to apply said mixed reactants.

15. The method according to claim 14, further comprising:
causing at least one reactant sealed inside multiple inner chambers to be released into said mixing chamber.

16. The method according to claim 14, further comprising:
wherein said at least one mixing chamber comprises an inner mixing chamber and an outer mixing chamber.

17. The method according to claim 14, further comprising:
causing the reactants to pass through a restriction between said inner mixing chamber and said outer mixing chamber.

18. The method according to claim 14, further comprising causing at least the reactants to pass between said inner mixing chamber and said outer mixing chamber multiple times.

19. The method according to claim 14, further comprising causing at least one reactant sealed inside multiple inner chambers to be released into said mixing chamber

20. The method according to claim 14, wherein said at least one reactant is sealed inside at least one pouch.
